(19) United States
(12) Patent Application Publication
(10) Pub. No.: US 2022/0237577 A1
(43) Pub. Date: Jul. 28, 2022

(54) Fair Share Group Ordering App

(71) Applicant: Simone Fleming, Stratford, NJ (US)

(72) Inventor: Simone Fleming, Stratford, NJ (US)

(21) Appl. No.: 17/157,212

(22) Filed: Jan. 25, 2021

(51) Int. Cl. G06Q 20/08; G06Q 30/04; G06Q 10/08; G06Q 40/02; G06Q 20/32; G06Q 30/06

(52) U.S. Cl. CPC G06Q 20/085; G06Q 30/04; G06Q 10/083; G06Q 30/0635; G06Q 20/321; G06Q 20/3223; G06Q 10/087; G06Q 40/02

(57) ABSTRACT

The disclosure is the only food order placement application with features developed specifically to ensure each person adequately contributes to a group order. It is designed to offer users the ability to earn extra income by delivering bulk food orders to friends who share a restaurant tab. The system for product delivery includes a group contact module to take input from participants and determine group orders and individual orders of products. A payments module receives payments via a credit account of each of the participants based on input from the group contact module regarding prices of the products ordered. An order module selects a vendor and computes a total cost for each order plus taxes and pay the vendor for the order via the payments module. A delivery module takes input from the participants to select a delivery or pickup for each respective order from the group contact module.

### BACKGROUND

Ordering food is a standard method of relieving hunger throughout the majority of the modern world. Persons often purchase large restaurant orders that involve multiple patrons. The payment for these large orders is typically charged to the account of one person who makes the order with an understanding that they will be compensated by all other patrons. However, persons often do not reimburse the person who may have funded the meal. This lack of reimbursement results in financial loss and reduced trust among individuals. There have been no products available as original equipment or as an aftermarket to address this problem.

An apparatus to simplify the process of paying and ordering group food orders. There have been no products available as original equipment or as an aftermarket to address this problem either.

There exists a need for a device and a system for group food orders that is not being met by any known or disclosed device or system of present.

### SUMMARY OF THE INVENTION

The main purpose of the disclosed product ordering system, application and methods, also known as Fair Share Group Ordering App, provides a method of ensuring all persons pay their share of a culinary order in an automated and easy to use application. The system for product delivery includes a group contact module configured to take input from participants and determine orders comprising group orders and individual orders of products. The system also includes a payments module configured to receive payments via a credit account of each of the participants based on input from the group contact module regarding prices of the products ordered. The system additionally includes an order module configured to select a vendor and compute a total cost for each order plus taxes and pay the vendor for the order via the payments module. The system further includes a delivery module configured to take input from the participants to select a delivery or pickup for each respective order from the group contact module.

### BRIEF DESCRIPTION OF THE DRAWINGS

FIG. 1 is a flow chart of the Fair Share Group Ordering System and Application in accordance with an embodiment of the present disclosure.

FIG. 2 is a block diagram of the Fair Share Group Ordering System in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the word ‘module’ refers to electrical circuits, register components, boolean logic and stored program products which transform a predetermined input into a prescribed output as respectively described herein

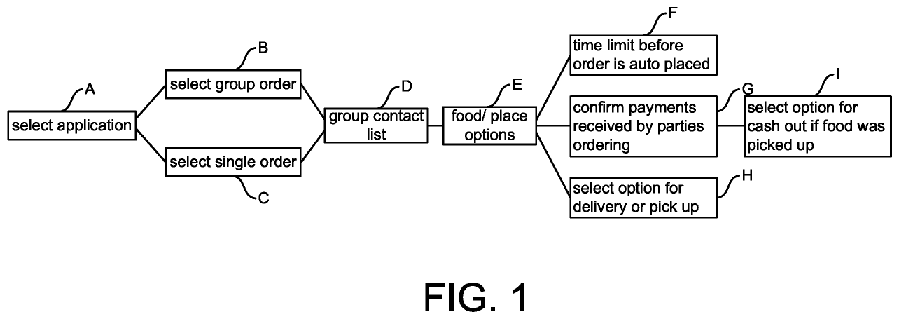

FIG. 1 is a flow chart of the Fair Share Group Ordering Application in accordance with an embodiment of the present disclosure. The flow chart includes A. Select the application module, B. Select Group Order module, or C. Select single order module, D. Use group contact list module when placing the order, E. Select the restaurant and food module that you wish to order, F. Time limit module for the order to be placed, G. Confirm payments module received from all parties ordering, H. Select option for delivery or to be picked up module and I. Select option for cash out module if food was picked up. This selection provides the person picking up the order for the group to receive the group tip for “picking up and delivering” the food.

Fair Share is an application that allows users to each pay for a group order. Once downloaded multiple persons would indicate their meal or grocery choice on the group order. Fair Share would then calculate the total of the order and subsequently bill each person for their share of the purchase, including tax. After everyone has paid for their portion of the meal then the order will be placed in an embodiment of the disclosure. This will eliminate the financial risk of purchasing an order and expecting reimbursement at a later date. Another option is to directly bill respective credit cards for orders given permission from the group members for the credit purchase in the order. Fair share improves the financial accountability in groups that purchase large orders of food in addition to reducing the high costs typically associated with food delivery since costs associated with food delivery are split among each member. Each person involved in the order will have the opportunity to provide a tip that will be paid to the group member who drives to retrieve the food order; this reduces delivery costs and is a great opportunity to earn income as a delivery contact.

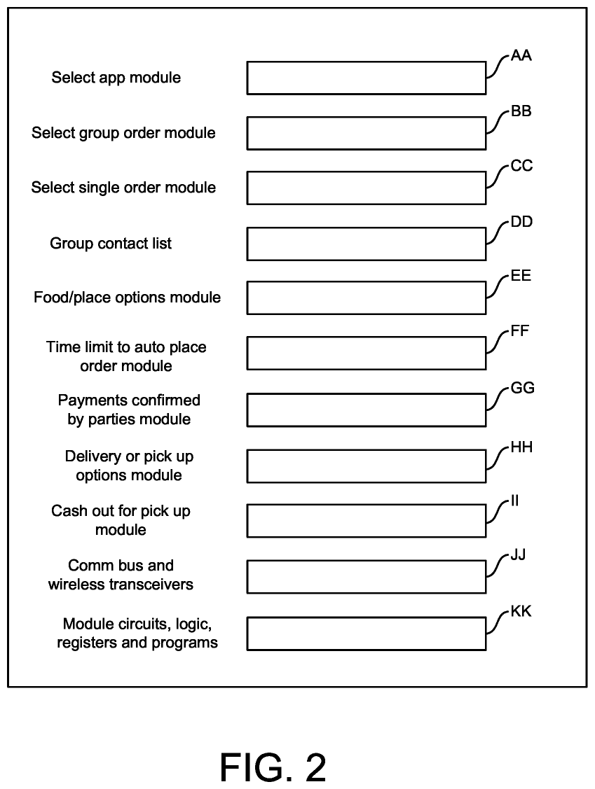

FIG. 2 is a block diagram of the Fair Share Group Ordering System in accordance with an embodiment of the present disclosure. The block diagram includes the respective modules of the flow chart of FIG. 1. Specifically, a select application module AA, a select group order module BB, a select single order module CC, a group contact list DD, a food/place options module EE, a time limit before order is auto place module FF, a confirm payments received by parties ordering GG, a select option for delivery or pickup HH and a select option for cash out if food is picked up module II. The modules are each in communication with all other modules via a communications bus and/or wireless circuits and transceivers JJ. The module circuits, logic, registers and computer program products and code for cell phone applications is comprised in KK. The top level system and implementation of a computer program product on a computer, cell phone and other personal digital assistant are included in embodiments of the present disclosure.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

The described techniques may be implemented as a method, apparatus or article of manufacture using standard programming and/or engineering techniques to produce software, firmware, hardware, or any combination thereof. The term “system” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, storage networks (e.g., SAN or NAS), etc.). The computer readable medium is accessed and executed by a processor. The resulting code in which described embodiments are implemented may further be accessible through a transmission medium or from a file server over a network. In such cases, the system in which the code is implemented may comprise a transmission media, such as a network transmission line, wireless transmission media, signals propagating through space, radio waves, infrared signals, etc. Thus, the “system” may comprise the medium in which the code is embodied.

Additionally, the “system” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

The steps disclosed describe specific operations of which some or more are occurring in a particular order. In alternative implementations, certain of the logic operations may be performed in a different order, modified or removed. Moreover, steps may be added to the above described logic and still conform to the described implementations. Further, operations described herein may occur sequentially or certain operations may be processed in parallel, or operations described as performed by a single process may be performed by distributed processes.

A file system associated with the disclosure may implement a processor (e.g., a microprocessor), a memory (e.g., a volatile memory device), and storage (e.g., a non-volatile storage area, such as magnetic disk drives, optical disk drives, a tape drive, etc.). An operating system may execute in memory. The storage may comprise an internal storage device or an attached or network accessible storage. Computer programs in storage may be loaded into the memory and executed by the processor in a manner known in the art. The system architecture further includes circuits to enable communication with a network. An input device is used to provide user input to the processor, and may include a keyboard, mouse, pen-stylus, microphone, touch sensitive display screen, or any other activation or input mechanism known in the art. An output device is capable of rendering information transmitted from the processor, or other component, such as a display monitor, printer, storage, etc. The file system architecture implementing the disclosed systems may include fewer components than illustrated, additional components not illustrated herein, or some combination of the components illustrated and additional components.

The disclosed file system and computer architecture may comprise any computing device known in the art, such as a mainframe, server, personal computer, workstation, laptop, handheld computer, telephony device, network appliance, virtualization device, storage controller, etc. Any processor and operating system known in the art may be used.

What is claimed is:

1. A system for product delivery:
a group contact module configured to take input from participants and determine orders comprising group orders and individual orders of products;
a payments module configured to receive payments via a credit account of each of the participants based on input from the group contact module regarding prices of the products ordered;
an order module configured to select a vendor and compute a total cost for each order plus taxes and pay the vendor for the order via the payments module; and
a delivery module configured to take input from the participants to select a delivery or pickup for each respective order from the group contact module.

2. The system for product delivery of claim 1, further comprising a time limit module configured to communicate with the order module to auto place the group order and the individual order upon an expiry of a predetermined time for the participants to get their order into the group contact list module.

3. The system for product delivery of claim 1, wherein the order module further comprises including a tip for a delivery participant from the group contact module.

4. The system for product delivery of claim 1, wherein the delivery module further comprises a cash out module configured to override the payments module in the event a participant picks up their own order.

5. The system for product delivery of claim 1, wherein the credit account of each of the participants includes cash transfers, credit card accounts and credits earned including tips from previous transactions of the product delivery system.

6. The system for product delivery of claim 1, further comprising selecting an application to run the system from a cell phone, a computer and another personal digital device including a watch and an embedded processor.

7. The system for product delivery of claim 1, wherein the product is groceries and toiletries ordered from a supermarket grocer.

8. The system for product delivery of claim 1, wherein the product is restaurant food made to order.

9. The system for product delivery of claim 1, wherein the product is clothing and apparel.

10. The system for product delivery of claim 1, wherein the product is medication and medical supplies.

11. The system for product delivery of claim 1, wherein the product is building maintenance supplies including heating and air conditioning filters, tissue, hand soap, window washing fluid and landscaping supplies.

12. The system for product delivery of claim 1, wherein the product is personal use materials including printed material, toys, electronics, and entertainment materials.

13. The system for product delivery of claim 1, wherein the product is home improvement and remodeling materials including lumber, hardware and tools.

14. A method for product delivery, the method comprising:
taking input from participants for determining orders comprising group orders and individual orders of products via a group contact module;
receiving payments via a credit account of each of the participants based on input from the group contact module regarding prices of the products ordered via a payments module;
selecting a vendor for computing a total cost for each order plus taxes via an order module and pay the vendor for the order via the payments module; and
delivering the products via a delivery module configured to take input from the participants to select a delivery or pickup for each respective order from the group contact module.

15. A computer program product comprising a computer readable storage medium having computer usable instruction codes executable to perform operations for managing a group order and product delivery service, the operations of the computer program product comprising:
taking input from participants for determining orders comprising group orders and individual orders of products via a group contact module;
receiving payments via a credit account of each of the participants based on input from the group contact module regarding prices of the products ordered via a payments module;
selecting a vendor for computing a total cost for each order plus taxes via an order module and pay the vendor for the order via the payments module; and
delivering the products via a delivery module configured to take input from the participants to select a delivery or pickup for each respective order from the group contact module.

16. The computer program product of claim 15, further comprising communicating with the order module to auto place the group order and the individual order upon an expiry of a predetermined time for the participants to get their order into the group contact list module.

17. The computer program product of claim 15, further comprising a tip module in communication with the order module configured to include a tip for a delivery participant from the group contact module.

18. The computer program product of claim 15, further comprises a cash out module in communication with the delivery module and configured to override the payments module in the event a participant picks up their own order.

19. The computer program product of claim 15, further comprising an accounting of a credit account of each of the participants including cash transfers, credit card accounts and credits earned including tips from previous transactions of the product delivery service.

20. The computer program product of claim 15, further comprising computer usable instruction codes executable to perform operations for managing a group order and product delivery service on a cell phone and a cell phone platform.
